(19) United States
(12) Patent Application Publication
(10) Pub. No.: US 2014/0256171 A1
(43) Pub. Date: Sep. 11, 2014

(54) Quick Connector Assembly

(71) Applicant: Li-Chen Liu, New Taipei City (TW)

(72) Inventor: Li-Chen Liu, New Taipei City (TW)

(21) Appl. No.: 13/792,497

(22) Filed: Mar. 11, 2013

(51) Int. Cl. H01R 13/623

(52) U.S. Cl. CPC H01R 13/623
USPC 439/349

(57) ABSTRACT

A quick connector assembly includes a first connector, a second connector, and a locking ring. The first connector has a protruding flange which has a plurality of terminal holes. The second connector has a mounting recess which has a plurality of terminals. Thus, the protruding flange of the first connector is inserted into the mounting recess of the second connector, and the terminals of the second connector are inserted into the terminal holes of the first connector, so that the first connector and the second connector are combined together.

### BACKGROUND OF THE INVENTION

1. Field of the Invention

The present invention relates to a connecting mechanism and, more particularly, to a quick connector assembly.

2. Description of the Related Art

A conventional quick connector assembly comprises a male connector and a female connector juxtaposed to and connected with the male connector. However, the male connector and the female connector are easily loosened and detached from each other during a long-term utilization, thereby causing inconvenience to the user, and thereby decreasing the efficiency of transmission of the conventional quick connector assembly.

### BRIEF SUMMARY OF THE INVENTION

In accordance with the present invention, there is provided a quick connector assembly, comprising a first connector, a second connector connected with the first connector, and a locking ring mounted on the second connector and locked onto the first connector. The first connector has a front end provided with a protruding flange. The protruding flange of the first connector has an inner side provided with a plurality of terminal holes. The protruding flange of the first connector has an outer wall provided with an external thread. The second connector has a front end provided with a mounting recess mounted on the protruding flange of the first connector. The mounting recess of the second connector is provided with an internal thread screwed onto the external thread of the first connector. The mounting recess of the second connector has a side provided with a plurality of terminals inserted into the terminal holes of the first connector. The number of the terminals of the second connector is equal to that of the terminal holes of the first connector. The locking ring is provided with an internal thread screwed onto the external thread of the first connector. In assembly, the protruding flange of the first connector is inserted into the mounting recess of the second connector, and the terminals of the second connector are inserted into the terminal holes of the first connector. Then, the locking ring is rotated on the second connector, and the internal thread of the locking ring is screwed onto the external thread of the first connector to lock the locking ring onto the first connector so as to connect the first connector with the locking ring.

The first connector is connected with a first connecting cord. The second connector is connected with a second connecting cord.

According to one embodiment of the present invention, the first connector has thirteen terminal holes, and the second connector has thirteen terminals.

According to another embodiment of the present invention, the first connector has fifteen terminal holes, and the second connector has fifteen terminals.

According to another embodiment of the present invention, the first connector has nineteen terminal holes, and the second connector has nineteen terminals.

According to another embodiment of the present invention, the first connector has twenty-one terminal holes, and the second connector has twenty-one terminals.

According to one embodiment of the present invention, the first connector is connected with the first connecting cord in a rotation locking manner, and the second connector is connected with a second connecting cord in a rotation locking manner.

According to another embodiment of the present invention, the first connector is connected with the first connecting cord in an insertion locking manner, and the second connector is connected with a second connecting cord in an insertion locking manner.

According to another embodiment of the present invention, the first connector is connected with the first connecting cord in a groove locking manner, and the second connector is connected with a second connecting cord in a groove locking manner.

Preferably, an O-ring is mounted on the protruding flange of the first connector to provide a waterproof function.

The primary objective of the present invention is to provide a quick connector assembly that is assembled solidly and stably.

According to the primary advantage of the present invention, the terminals of the second connector are inserted into the terminal holes of the first connector when the protruding flange of the first connector is inserted into the mounting recess of the second connector, so that the first connector and the second connector are combined together solidly and stably and will not be detached from each other.

According to another advantage of the present invention, the first connector and the second connector are connected easily and quickly.

According to a further advantage of the present invention, the terminals of the second connector co-operate with the terminal holes of the first connector for transmission of analogue and digital signals, thereby enhancing the versatility of the quick connector assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a quick connector assembly in accordance with the preferred embodiment of the present invention.

FIG. 2 is an exploded perspective view of the quick connector assembly as shown in FIG. 1.

FIG. 3 is a cross-sectional view of the quick connector assembly as shown in FIG. 1.

FIG. 4 is a partially exploded perspective view of a quick connector assembly in accordance with another preferred embodiment of the present invention.

FIG. 5 is a partially exploded perspective view of a quick connector assembly in accordance with another preferred embodiment of the present invention.

FIG. 6 is a partially exploded perspective view of a quick connector assembly in accordance with another preferred embodiment of the present invention.

FIG. 7 is a partially exploded perspective view of a quick connector assembly in accordance with another preferred embodiment of the present invention.

### DETAILED DESCRIPTION OF THE INVENTION

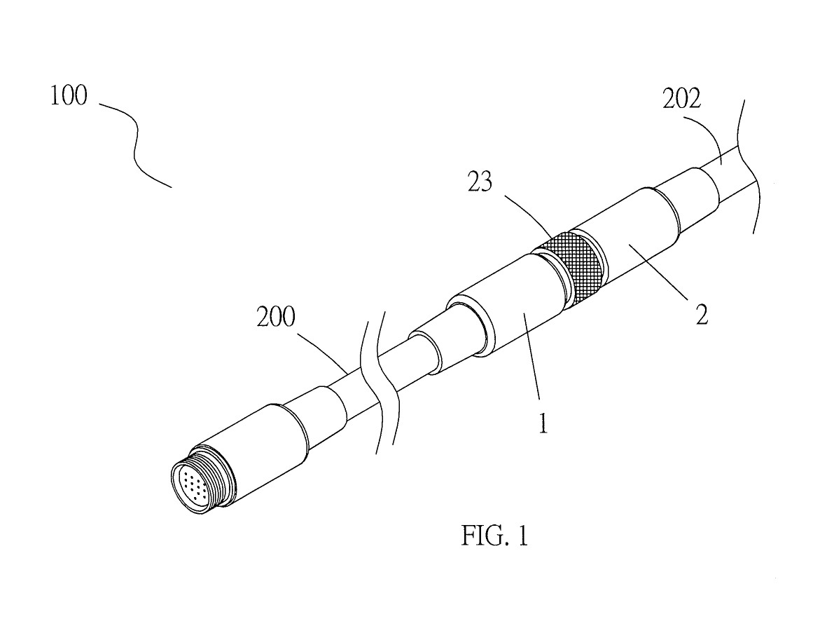

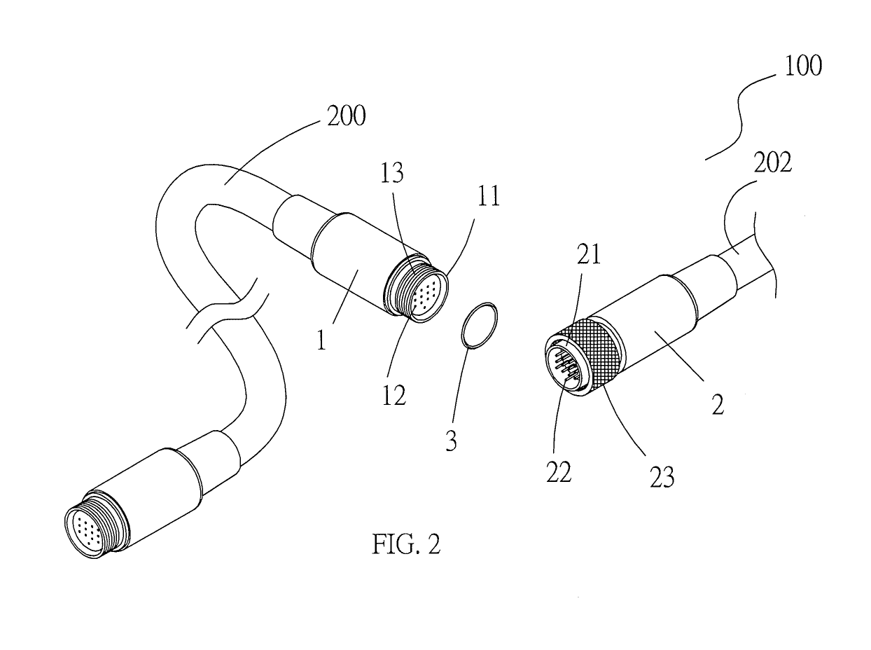

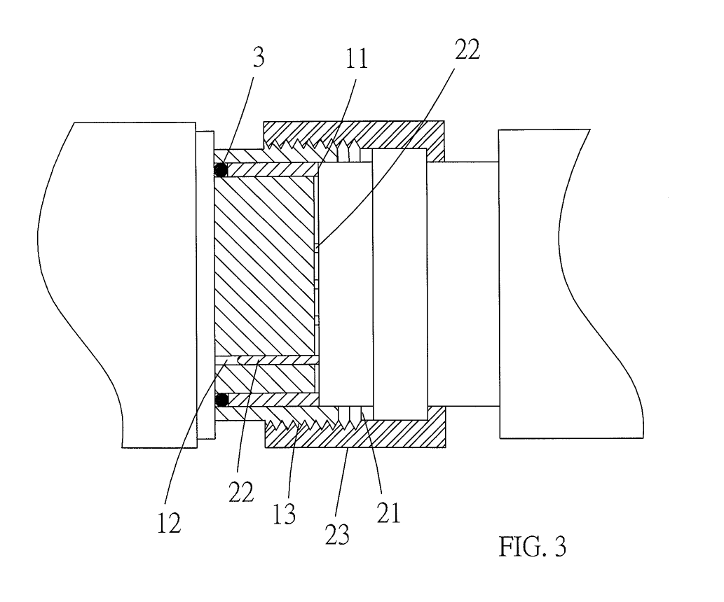

Referring to the drawings and initially to FIGS. 1-3, a quick connector assembly 100 in accordance with the preferred embodiment of the present invention comprises a first connector 1, a second connector 2 connected with the first connector 1, and a locking ring 23 mounted on the second connector 2 and locked onto the first connector 1.

The first connector 1 has a front end provided with a protruding flange 11. The protruding flange 11 of the first connector 1 has an inner side provided with a plurality of terminal holes 12. The protruding flange 11 of the first connector 1 has an outer wall provided with an external thread 13. An O-ring 3 is mounted on the protruding flange 11 of the first connector 1 to provide a waterproof function. In the preferred embodiment of the present invention, the first connector 1 is connected with a first connecting cord 200.

The second connector 2 has a front end provided with a mounting recess 21 mounted on the protruding flange 11 of the first connector 1. The mounting recess 21 of the second connector 2 is provided with an internal thread screwed onto the external thread 13 of the first connector 1. The mounting recess 21 of the second connector 2 has a side provided with a plurality of terminals 22 inserted into the terminal holes 12 of the first connector 1. The terminals 22 of the second connector 2 co-operate with the terminal holes 12 of the first connector 1 for transmission of analogue or digital signals. The number of the terminals 22 of the second connector 2 is equal to that of the terminal holes 12 of the first connector 1. In the preferred embodiment of the present invention, the second connector 2 is connected with a second connecting cord 202.

The locking ring 23 is rotatably mounted on the second connector 2 and is releasably locked onto the first connector 1. The locking ring 23 is provided with an internal thread screwed onto the external thread 13 of the first connector 1.

In assembly, the protruding flange 11 of the first connector 1 is inserted into the mounting recess 21 of the second connector 2, and the terminals 22 of the second connector 2 are inserted into the terminal holes 12 of the first connector 1. Then, the locking ring 23 is rotated on the second connector 2, and the internal thread of the locking ring 23 is screwed onto the external thread 13 of the first connector 1 to lock the locking ring 23 onto the first connector 1 so as to connect the first connector 1 with the locking ring 23.

Accordingly, the terminals 22 of the second connector 2 are inserted into the terminal holes 12 of the first connector 1 when the protruding flange 11 of the first connector 1 is inserted into the mounting recess 21 of the second connector 2, so that the first connector 1 and the second connector 2 are combined together solidly and stably and will not be detached from each other. In addition, the first connector 1 and the second connector 2 are connected easily and quickly. Further, the terminals 22 of the second connector 2 co-operate with the terminal holes 12 of the first connector 1 for transmission of analogue and digital signals, thereby enhancing the versatility of the quick connector assembly.

In the preferred embodiment of the present invention, the first connector 1 is connected with the first connecting cord 200 in a rotation locking manner, and the second connector 2 is connected with a second connecting cord 202 in a rotation locking manner. Alternatively, the first connector 1 is connected with the first connecting cord 200 in an insertion locking manner, and the second connector 2 is connected with a second connecting cord 202 in an insertion locking manner. Alternatively, the first connector 1 is connected with the first connecting cord 200 in a groove locking manner, and the second connector 2 is connected with a second connecting cord 202 in a groove locking manner.

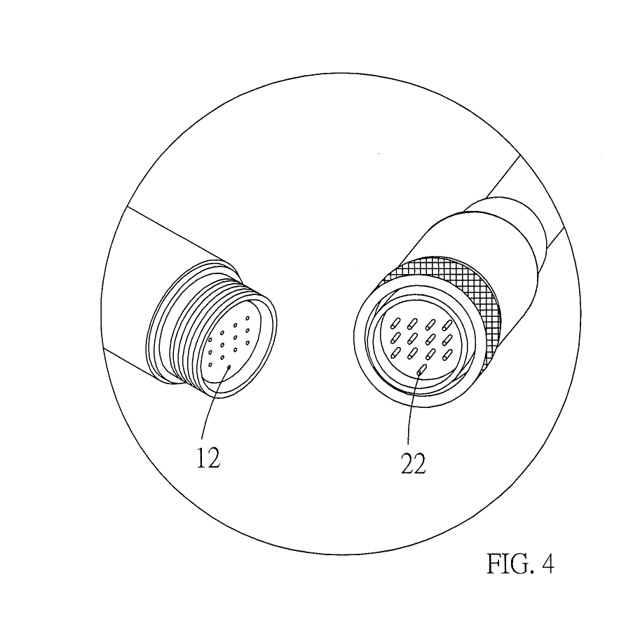

As shown in FIG. 4, the first connector 1 has thirteen (13) terminal holes 12, and the second connector 2 has thirteen (13) terminals 22.

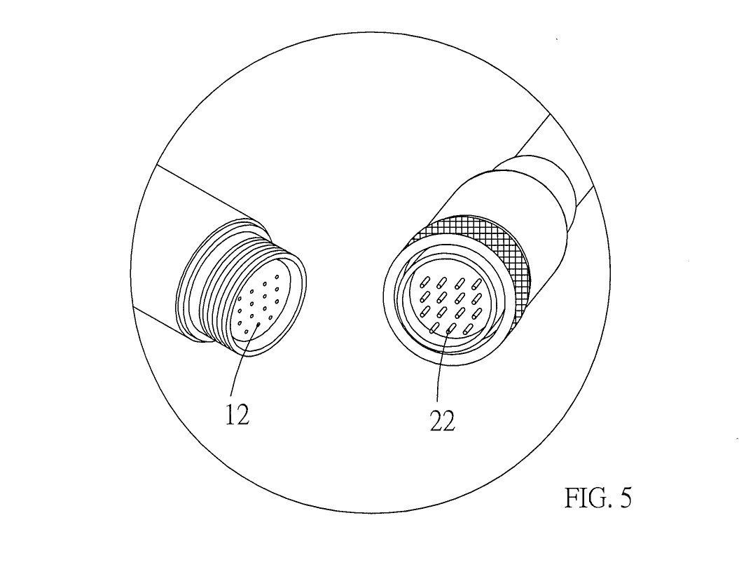

As shown in FIG. 5, the first connector 1 has fifteen (15) terminal holes 12, and the second connector 2 has fifteen (15) terminals 22.

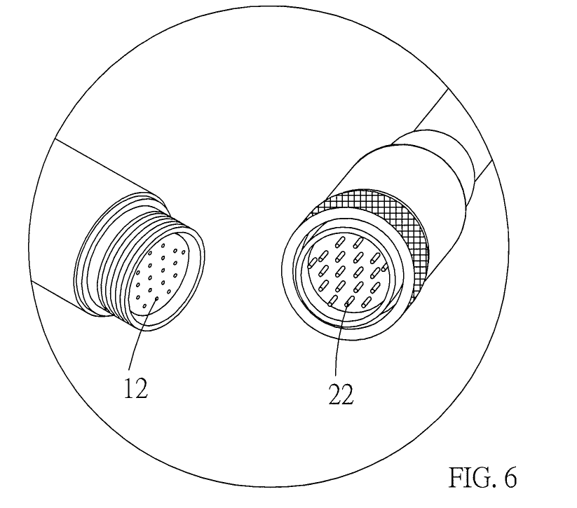

As shown in FIG. 6, the first connector 1 has nineteen (19) terminal holes 12, and the second connector 2 has nineteen (19) terminals 22.

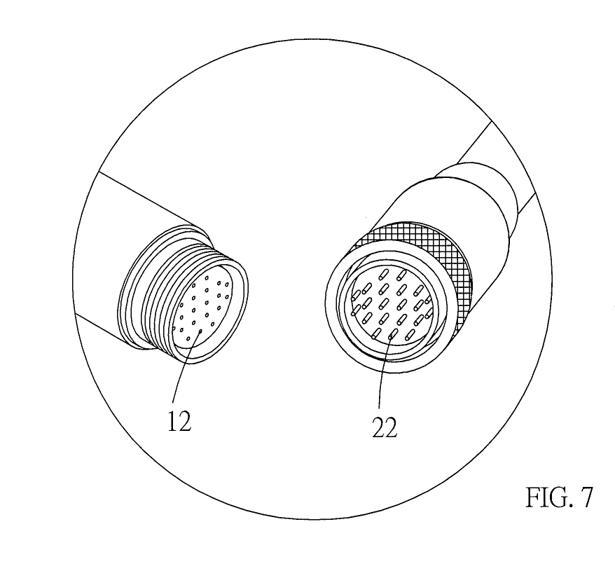

As shown in FIG. 7, the first connector 1 has twenty-one (21) terminal holes 12, and the second connector 2 has twenty-one (21) terminals 22.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A quick connector assembly, comprising:
a first connector;
a second connector connected with the first connector; and
a locking ring mounted on the second connector and locked onto the first connector; wherein:
the first connector has a front end provided with a protruding flange;
the protruding flange of the first connector has an inner side provided with a plurality of terminal holes;
the protruding flange of the first connector has an outer wall provided with an external thread;
the second connector has a front end provided with a mounting recess mounted on the protruding flange of the first connector;
the mounting recess of the second connector is provided with an internal thread screwed onto the external thread of the first connector;
the mounting recess of the second connector has a side provided with a plurality of terminals inserted into the terminal holes of the first connector;
the number of the terminals of the second connector is equal to that of the terminal holes of the first connector;
the locking ring is provided with an internal thread screwed onto the external thread of the first connector;
the protruding flange of the first connector is inserted into the mounting recess of the second connector, and the terminals of the second connector are inserted into the terminal holes of the first connector;
the locking ring is rotated on the second connector, and the internal thread of the locking ring is screwed onto the external thread of the first connector to lock the locking ring onto the first connector so as to connect the first connector with the locking ring.

2. The quick connector assembly of claim 1, wherein the first connector is connected with a first connecting cord, and the second connector is connected with a second connecting cord.

3. The quick connector assembly of claim 1, wherein the first connector has thirteen terminal holes, and the second connector has thirteen terminals.

4. The quick connector assembly of claim 1, wherein the first connector has fifteen terminal holes, and the second connector has fifteen terminals.

5. The quick connector assembly of claim 1, wherein the first connector has nineteen terminal holes, and the second connector has nineteen terminals.

6. The quick connector assembly of claim 1, wherein the first connector has twenty-one terminal holes, and the second connector has twenty-one terminals.

7. The quick connector assembly of claim 2, wherein the first connector is connected with the first connecting cord in a rotation locking manner, and the second connector is connected with a second connecting cord in a rotation locking manner.

8. The quick connector assembly of claim 2, wherein the first connector is connected with the first connecting cord in an insertion locking manner, and the second connector is connected with a second connecting cord in an insertion locking manner.

9. The quick connector assembly of claim 2, wherein the first connector is connected with the first connecting cord in a groove locking manner, and the second connector is connected with a second connecting cord in a groove locking manner.

10. The quick connector assembly of claim 1, further comprising:
an O-ring mounted on the protruding flange of the first connector to provide a waterproof function.
